(19) United States
(12) Patent Application Publication
(10) Pub. No.: US 2020/0300312 A1
(43) Pub. Date: Sep. 24, 2020

(54) Sealed Hydraulic Stop Valve for Caliper Guide Pin Assembly

(71) Applicant: John Arthur Kelvin, China Township, MI (US)

(72) Inventor: John Arthur Kelvin, China Township, MI (US)

(21) Appl. No.: 16/894,501

(22) Filed: Jun. 5, 2020

Related U.S. Application Data
(63) Continuation-in-part of application No. 15/997,081, filed on Jun. 4, 2018, now Pat. No. 10,677,299.
(60) Provisional application No. 62/538,913, filed on Jul. 31, 2017.

(51) Int. Cl. F16D 55/2265; F16K 21/04; F16D 65/00

(52) U.S. Cl. CPC F16D 55/22655; F16K 21/04; F16D 2055/007; F16D 65/0093; F16D 65/005; F16D 65/0087

(57) ABSTRACT

A sealed hydraulic stop valve for caliper guide system of an air disk brake system provides a means of continuous maintenance and lubrication. The system includes a tubular guide pin, a cap, a sealed hydraulic stop valve, and a plurality of lubricating grooves. The tubular guide pin attaches a caliper head to a carrier of the air disk brakes. The lubricating grooves inject grease into the system and are radially distributed about the tubular guide pin. Each lubricating groove normally and externally traverses into the tubular guide pin. The cap and the stop valve seal off the tubular guide pin and allow for grease injection to the lubricating grooves. The cap is concentrically positioned about the tubular guide pin. The stop valve is adjacently integrated into the cap, opposite to the tubular guide pin. Resultantly, the stop valve is in fluid communication with each of the lubricating grooves.

The current application is a continuation-in-part (CIP) application of a U.S. non-provisional application Ser. No. 15/997,081 filed on Jun. 4, 2018. The U.S. non-provisional application Ser. No. 15/997,081 claims a priority to a U.S. provisional application Ser. No. 62/538,913 filed on Jul. 31, 2017.

### FIELD OF THE INVENTION

The present invention relates generally to a brake system of an automotive vehicle. In particular, the present invention is a sealed hydraulic stop valve for caliper guide pin assembly of an air disk brake that is generally used in heavy equipment, commercial trucks, and trailers to protect the structural integrity of the stored greased within the caliper guide pin assembly.

### BACKGROUND OF THE INVENTION

Air disk brakes have been widely adopted in Europe, primarily as result of their performance advantages over conventional drum brakes. These high-performance brakes are now being widely adopted in U.S. commercial vehicles and industry experts predict air disc braking systems will consume 30% of the US commercial vehicle market by 2020. One major problem faced by users of these brake calipers is their inherent ability to seize up and cause brake failure during service. Air disc calipers, like most brake calipers, comprise two-pieces of iron. One piece known as the carrier, saddle, or bracket, and is bolted to the wheel end in a fixed position. For the purposes of this discussion, we shall hereafter refer to this as the carrier. The second piece of iron is known as the caliper head or caliper body. It contains the mechanical components that receive actuation from an actuating mechanism (i.e. air chamber), and then converts the force from the actuator into mechanical leverage that operates pistons or threaded tappets. Those pistons or tappets then advance to create brake torque. No brake torque or clamping force can be created unless the caliper head can be pulled into the carrier in such a manner as to create the clamping force necessary for the brake pads to clamp the brake disc and retard the vehicle motion. To affect this free motion between the caliper head and carrier, original equipment manufacturers have designed the caliper with a guide pin assembly (sometimes also referred to as a slide pin or slide pin assembly). This assembly consists generally of one or more bushings that fit inside a bore on the caliper head. These bushings may be made of bronze, brass or steel and may or may not be dimpled. A lubricated steel guide pin is then inserted into the bushing. This guide pin is then bolted into the carrier, attaching the carrier to the caliper head, and providing a mechanism for lateral travel from which clamping force can be derived. Between the carrier and the caliper head is a rubber boot that seals the guide pin assembly on one end. At the back end of the caliper is a metal sealing cap that is pressed into the caliper to seal the guide pin assembly. All major manufacturers of calipers use this same process for the guide pin or slide pin assembly. In all cases, their design is defective and such defect results in extremely high maintenance costs for commercial vehicle fleets, and potential catastrophic brake failure for individual vehicles. The cause of this failure is that original equipment (OE) manufacturers have engineered calipers so that they cannot be regularly lubricated and maintained in such a manner as to extend the life of the guide pin assembly. As a result, the high-performance caliper will operate at temperatures exceeding 1,500 degrees Fahrenheit, and will constantly endure torque loads of more than 15,000 lb.-ft. The combination of this high temperature and high torque causes the grease in the guide pin mechanism to literally evaporate, thus ceasing lubrication between the caliper head and carrier. Because there is no mechanism to service the unit (short of a complete replacement of the guide pin assemblies), the caliper continues to deteriorate until it seizes and creates exceptionally high costs of replacement, or catastrophic brake failure.

It is therefore an objective of the present invention to provide a sealed hydraulic stop valve for caliper guide pin assembly which provides a sealed compartment for the stored lubrication that is delivered to the guide pin and bushing of a caliper head. Protecting the structural integrity of the lubricant allows the guide pin and bushing to be continually serviced on an ongoing basis therefore improving the fatigue life of the caliper. The present invention creates an airtight compartment that can be easily rotate between a closed position to maintain the lubricant within guide pin assembly and an opened position to input the lubricant into the guide pin assembly.

### BRIEF DESCRIPTION OF THE DRAWINGS

FIG. 1 is a perspective view of the present invention.

FIG. 2 is an exploded view of the present invention.

FIG. 3 is a perspective view of the enlarged tubular guide pin and the lubrication directional plug of the present invention.

FIG. 4 is a cross-sectional view of the tubular guide pin.

FIG. 5 is a perspective view of an alternative embodiment of the present invention in an exploded state.

FIG. 6 is a bottom perspective view of the grease valve for the sealed hydraulic stop valve.

FIG. 7 is a side of the grease valve for the sealed hydraulic stop valve, showing the plane upon which a cross sectional view is take shown in FIG. 8.

FIG. 8 is a cross section view of the grease valve for the sealed hydraulic stop valve taken along line 8-8 of FIG. 7.

FIG. 9 is a bottom perspective view of the coupler for the sealed hydraulic stop valve.

FIG. 10 is a side of the coupler for the sealed hydraulic stop valve, showing the plane upon which a cross sectional view is take shown in FIG. 11.

FIG. 11 is a cross section view of the coupler for the sealed hydraulic stop valve taken along line 11-11 of FIG. 10.

FIG. 12 is a schematic view of the present invention shown within the opened configuration.

FIG. 13 is a schematic view of the present invention shown within the closed configuration.

### DETAIL DESCRIPTIONS OF THE INVENTION

All illustrations of the drawings are for the purpose of describing selected versions of the present invention and are not intended to limit the scope of the present invention.

The present invention generally relates to a brake system of an automotive vehicle. More specifically, the present invention relates to air disk brake and internal lubrication thereof. The present invention is a sealed hydraulic stop valve for caliper guide pin assembly which is capable of being continually serviced on an ongoing basis for increased product longevity. The present invention prevents costly maintenance and potential catastrophic brake failure due to a lack of guide pin lubrication (grease) and introduction of outside elements that can compromise the structural integrity of the stored lubrication. The present invention is designed as an aftermarket kit for air disk brakes but could be added to OE manufactured parts as an OE offering.

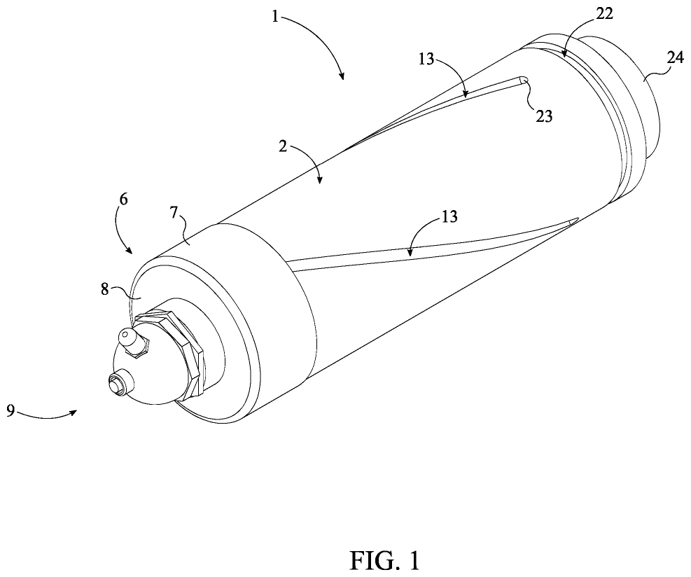

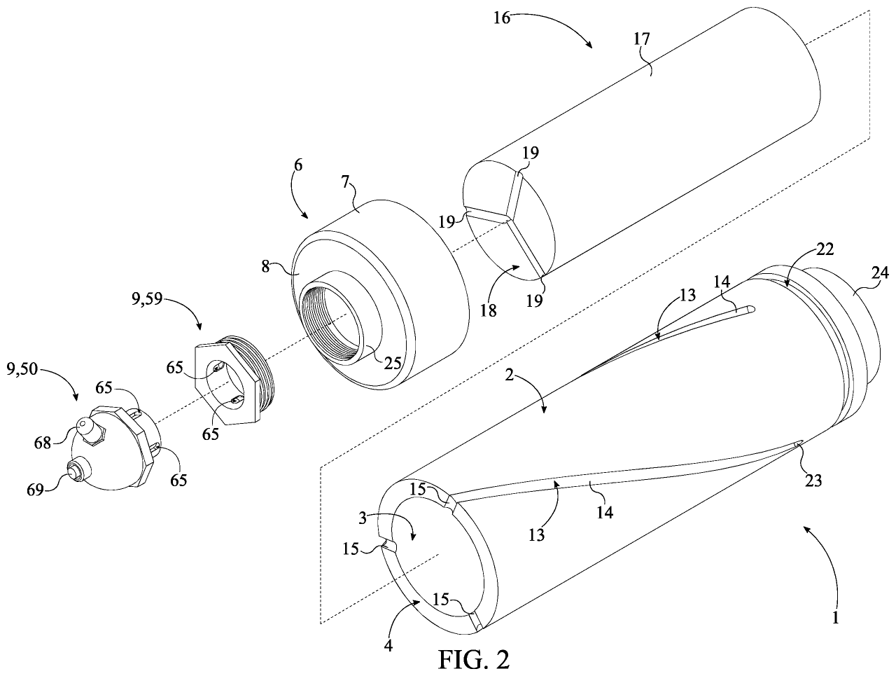

Referring to FIG. 1-2, the present invention comprises a tubular guide pin 1, a cap 6, a sealed hydraulic stop valve 9, and a plurality of lubricating grooves 13. The tubular guide pin 1 acts as the guide pin, or also known as a slide pin, which acts as a track for a caliper head in the air disk brake assembly. The tubular guide pin 1 allows for the caliper head to translate towards and away from a carrier of the air disk brake assembly, similar to traditional guide pins. The size, material composition, and design of the tubular guide pin 1 are subject to fit a variety of air disk brake assemblies. Each of the plurality of lubricating grooves 13 provides a means of applying/dispersing grease to the interface surfaces between the tubular guide pin 1 and a receiving bore of the carrier. In particular, the interface surfaces include an external surface 2 of the tubular guide pin 1 and the internal surface of the receiving bore or bushings of the caliper head. In order to ensure total coverage of the interface surfaces, the plurality of lubricating grooves 13 is radially distributed about the tubular guide pin 1; wherein, each of the plurality of lubricating grooves 13 normally traverses into the tubular guide pin 1 from the external surface 2 of the tubular guide pin 1. Thus, any grease introduced to the plurality of lubricating grooves 13 disperses and covers all the interface surfaces. The grease is introduced to the plurality of lubricating grooves 13 through a front surface 4 of the tubular guide pin 1. In particular, each of the plurality of lubricating grooves 13 traverses into the tubular guide pin 1 from the front surface 4 of the tubular guide pin 1. The grease within the present invention is retained and sealed off by the cap 6. The cap 6 is concentrically positioned with the tubular guide pin 1. Additionally, the cap 6 is positioned about the tubular guide pin 1, adjacent to the front surface 4 of the tubular guide pin 1, in order to form a liquid seal at the front surface 4 of the tubular guide pin 1.

The front surface 4 of the tubular guide pin 1 receives the grease through the sealed hydraulic stop valve 9. The sealed hydraulic stop valve 9 is a hydraulic valve that receives, regulates, and distributes grease into the present invention. A variety of different types of hydraulic valves may be used as the sealed hydraulic stop valve 9. In particular, the sealed hydraulic stop valve 9 is positioned adjacent to the cap 6, opposite the tubular guide pin 1, to allow for grease injection without full deconstruction and maintenance of the caliper. The sealed hydraulic stop valve 9 is adjacently integrated into the cap 6 in order to establish a fluid connection between an external environment and the interior of the cap 6, i.e. the front surface 4 of the tubular guide pin 1. Resultantly, the sealed hydraulic stop valve 9 is fluid communication with each of the plurality of lubricating grooves 13.

Referring to FIG. 1-2, it is preferred that each of the plurality of lubricating grooves 13 is curved for maximum grease penetration. In particular, each of the plurality of lubricating grooves 13 comprises a curved portion 14 and a guide portion 15. The curved portion 14 is an elongated narrow cut or depression that is positioned extending along the tubular guide pin 1. Additionally, the elongated narrow cut curves along a semi-helical (a semi-circular) path with a central axis being the central axis of the tubular guide pin 1. This ensures that all portions of the external surface 2 for the tubular guide pin 1 are covered in grease. The guide portion 15 is a small cut or depression in the front surface 4 of the tubular guide pin 1 that receives grease and directs said grease towards the curved portion 14. More specifically, the guide portion 15 is positioned adjacent to the front surface 4 of the tubular guide pin 1 and extends from an internal surface 3 of the tubular guide pin 1 to the external surface 2 of the tubular guide pin 1. Additionally, the guide portion 15 is positioned adjacent to the curved portion 14 in order to put the guide portion 15 in fluid communication with the curved portion 14. The length, size, cross-section, number of, and positioning of the plurality of lubricating grooves 13 is subject to change to meet the needs and requirements of different brake assemblies as well as the needs of the user. In a preferred embodiment of the present invention, a cross-section of each of the plurality of lubricating grooves 13 is preferably semi-circular shaped.

Referring to FIG. 2, similar to traditional designs, the cap 6 comprises a tubular portion 7 and a disk portion 8. The tubular portion 7 is an elongated tube sized to complimentary fit over the tubular guide pin 1 to attach the cap 6 to the tubular guide pin 1. More specifically, the tubular portion 7 is concentrically positioned about the tubular guide pin 1, adjacent to the front surface 4 of the tubular guide pin 1. The disk portion 8 is a thin circular structure which closes off the tubular portion 7 and, thus, the tubular guide pin 1. The disk portion 8 is concentrically positioned with the tubular portion 7. Additionally, the disk portion 8 is terminally and perimetrically connected to the tubular portion 7.

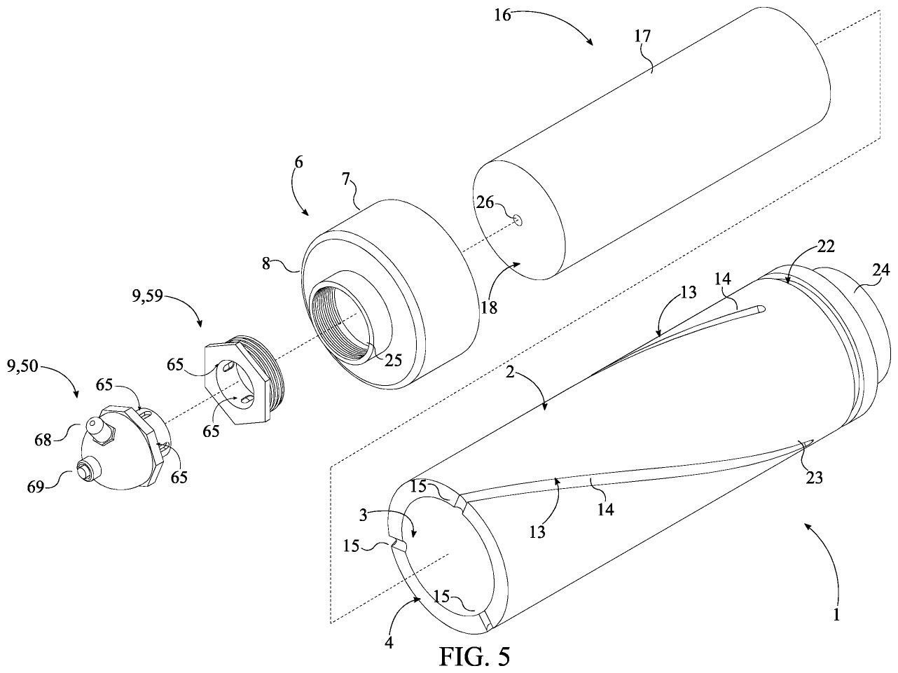

Referring to FIG. 5, the lubrication directional plug 16 fills the internal space of the tubular guide pin 1, thus forcing any grease introduced through the sealed hydraulic stop valve 9 to be redirected to the plurality of lubricating grooves 13. Referring to FIG. 2, the lubrication directional plug 16 comprises a cylindrical body 17 and a plurality of directional grooves 19. The cylindrical body 17 is complimentary sized to the internal space of the tubular guide pin 1. The cylindrical body 17 is concentrically positioned within the tubular guide pin 1 with a front surface 18 of the cylindrical body 17 being positioned coplanar with the front surface 4 of the tubular guide pin 1. Thus, the front surface 18 of the cylindrical body 17 receives the grease being injected through the sealed hydraulic stop valve 9. The plurality of directional grooves 19 receives the injected grease and redirects it to plurality of lubricating grooves 13. In particular, the plurality of directional grooves 19 is radially distributed about the cylindrical body 17; wherein each of the plurality of directional grooves 19 normally traverses into the front surface 18 of the cylindrical body 17. For efficient flow of grease, each of the plurality of directional grooves 19 is in fluid communication with a corresponding groove from the plurality of lubricating grooves 13. In an alternative embodiment, the lubrication directional plug 16 comprises only the cylindrical body 17 as any grease entering through the sealed hydraulic stop valve 9 still leaks toward the plurality of lubricating grooves 13.

The number within the plurality of directional grooves 19 preferably matches the number within the plurality of lubricating grooves 13. Additionally, the size, geometry, and design of each of the plurality of directional grooves 19 matches the size, geometry, and design of each of the plurality of lubricating grooves 13. This ensures a smooth fluid flow between the plurality of directional grooves 19 and the plurality of lubricating grooves 13. More specifically, a cross-section for each of the plurality of directional grooves 19 is semi-circular shaped. Furthermore, in the preferred embodiment of the present invention, a first end 20 of each of the plurality of directional grooves 19 is positioned coincident with each other, at the center of the front surface 18 of the cylindrical body 17. The center of the front surface 18 of the cylindrical body 17 coincides with an output of the sealed hydraulic stop valve 9; and resultantly, the first end 20 of each of the plurality of directional grooves 19 receives the grease entered into the present invention through the sealed hydraulic stop valve 9. A second end 21 of each of the plurality of directional grooves 19 is positioned adjacent with a corresponding groove from the plurality of lubricating grooves 13 to establish a fluid communication.

Referring to FIG. 5, in one embodiment of the present invention, the lubrication directional plug 16 comprises the cylindrical body 17 and a removal hole 26. In the preferred embodiment, the front surface 18 of the cylindrical body 17 redirects grease towards the plurality of lubricating grooves 13. The cylindrical body 17 is concentrically positioned within the tubular guide pin 1 with the front surface 18 of the cylindrical body 17 being positioned coplanar with the front surface 4 of the tubular guide pin 1. The removal hole 26 provides a means of removing the cylindrical body 17 from the tubular guide pin 1. More specifically, the removal hole 26 concentrically traverses into the front surface 18 of the cylindrical body 17 such that a pick may be inserted into the removal hole 26 and pull the lubrication directional plug 16 out of the tubular guide pin 1.

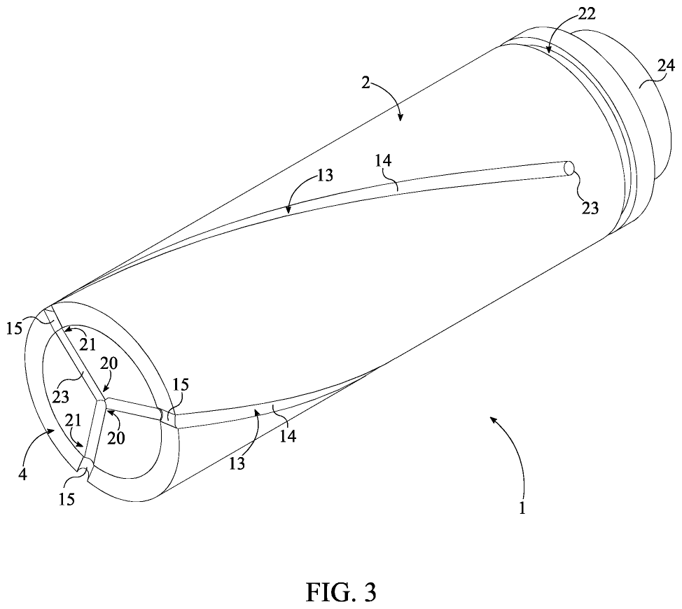

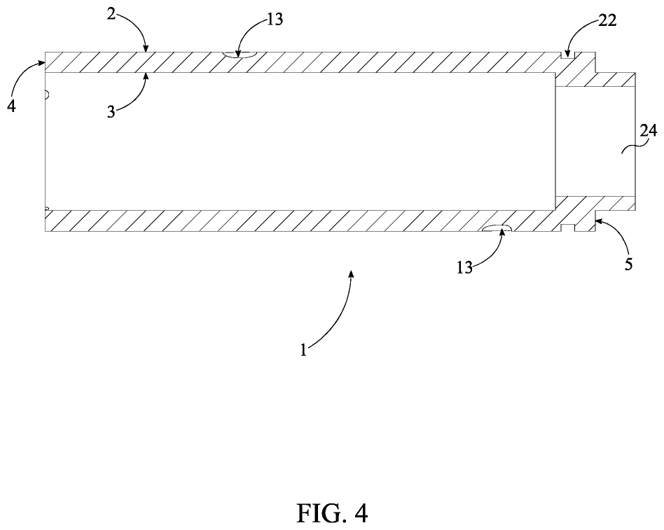

Referring to FIG. 3 and FIG. 4, for mounting and installment purposes, in the preferred embodiment of the present invention comprises an annular groove 22 and a mounting tube 24. The annular groove 22 is positioned adjacent to a rear surface 5 of the tubular guide pin 1. Additionally, the annular groove 22 laterally traverses into the tubular guide pin 1 from the external surface 2 of the tubular guide pin 1. In order to prevent over greasing and possibly hydro-locking the assembly, a grease dam is used. The grease dam prevents grease from filling any portions besides the interface surfaces. More specifically, the grease dam is formed by positioning a distal end 23 of each of the plurality of lubricating grooves 13 offset from the annular groove 22, thus creating a physical barrier. The grease dam limits the amount of grease allowed in the present invention. Once grease reaches the grease dam of each of the plurality of lubricating grooves 13, back pressure is created which causes the sealed hydraulic stop valve 9 to cease inputting process of grease. The offset distance between the distal end 23 of each of the plurality of lubricating grooves 13 and the annular groove 22 is subject to change to meet various performance and lubrication needs. The mounting tube 24 allows the tubular guide pin 1 to be fastened to the carrier. The mounting tube 24 is positioned adjacent to the rear surface 5 of the tubular guide pin 1 and is concentrically positioned within the tubular guide pin 1. More specifically, a first portion of the mounting tube 24 is positioned within the tubular guide pin 1 and a second portion of the mounting tube 24 is externally positioned to the tubular guide pin 1. The mounting tube 24 is laterally and perimetrically connected to the tubular guide pin 1. The first portion acts as an interlocking component by fitting in a corresponding bore of the carrier head. This anchors the mounting tube 24 to the carrier head in terms of lateral movement. The second portion acts as a flange for a fastening bolt. The fastening bolt traverses through the mounting tube 24 with a head portion pressing against the second portion and the threaded portion of the fastening bolt being engaged to the carrier head. Resultantly, the present invention is secured to the carrier head.

In alternative embodiments of the present invention, other mounting and installment means, components, and methods may be utilized depending on the type of caliper, manufacturing methods, vehicle type/brand, and other similar factors. For alternative means, one particular characteristic is consistent, the grease dam. In general, the distal end 23 of each of the plurality of lubricating grooves 13 is positioned offset from the rear surface 5 of the tubular guide pin 1.

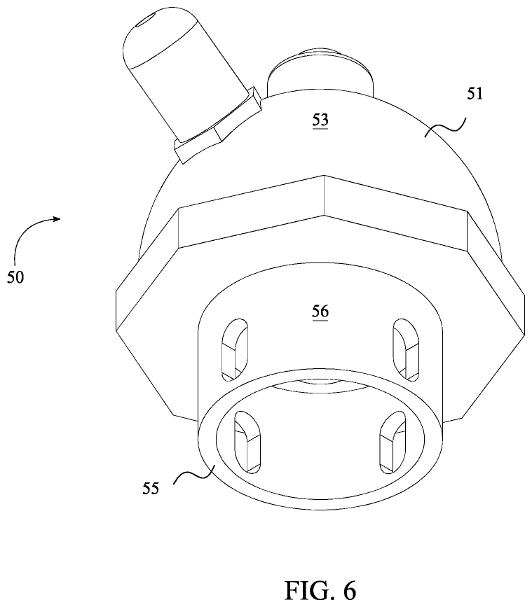

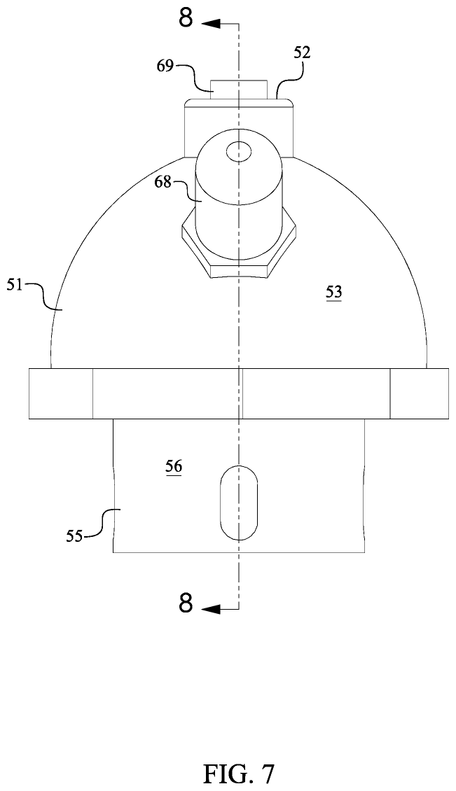

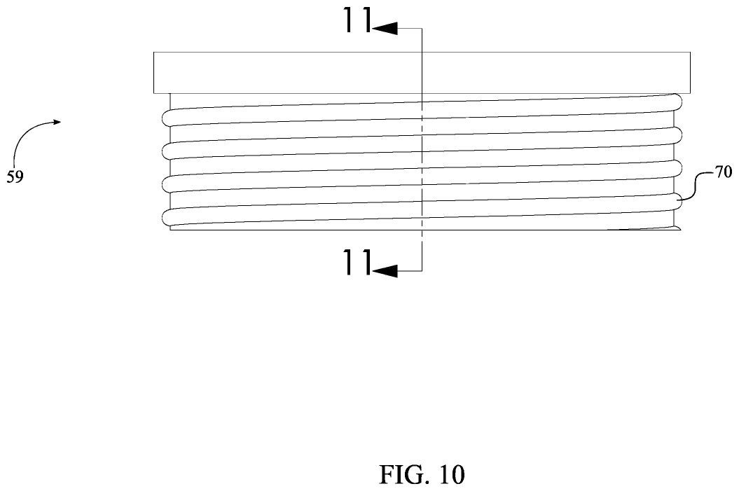

Referring to FIG. 2 and FIG. 6-11, the sealed hydraulic stop valve 9 is a hydraulic shut-off valve and comprises a grease valve 50, a coupler 59, a plurality of outlet channels 65, an overflow fitting 69, and an input fitting 68. Referring to FIG. 6-8, the grease valve 50 that function as the rotatable component within the sealed hydraulic stop valve 9 comprises a main body 51, a tubular attachment 55, an inlet opening 57, and a main feed chamber 58. In reference to general configuration of the sealed hydraulic stop valve 9, the main body 51 and the tubular attachment 55 are adjacently connected to each other in such a way that the main body 51 and the tubular attachment 55 are concentrically positioned along a central axis. The main body 51 is preferably formed into a hemispherical shape thus providing a tangential surface for input fitting 68 to be mounted or connected. The tubular attachment 55 is preferably a cylindrical body thus allowing tubular attachment 55 to be rotatably mounted within the coupler 59. The main feed chamber 58 traversing into the tubular attachment 55 from a top surface 52 of the main body 51 and delineates an elongated channel. The inlet opening 57 traverses into the main feed chamber 58 from a lateral surface 53 of the main body 51, wherein the inlet opening 57 angularly intersects with the main feed chamber 58. The overflow fitting 69 is slidably positioned within the main feed chamber 58 to regulate the amount of grease within the present invention. The input fitting 68 is externally connected onto the lateral surface 53 so that grease can be injected into the sealed hydraulic stop valve 9. As a result, the inlet opening 57 is selectively in fluid communication with the coupler 59 through the plurality of outlet channels 65 so that the grease can be distributed into the present invention. The inlet opening 57 is selectively in fluid communication with an overflow opening 54 of the main body 51 through the overflow fitting 69 so that the overflow fitting 69 can be activated regulate the amount of grease.

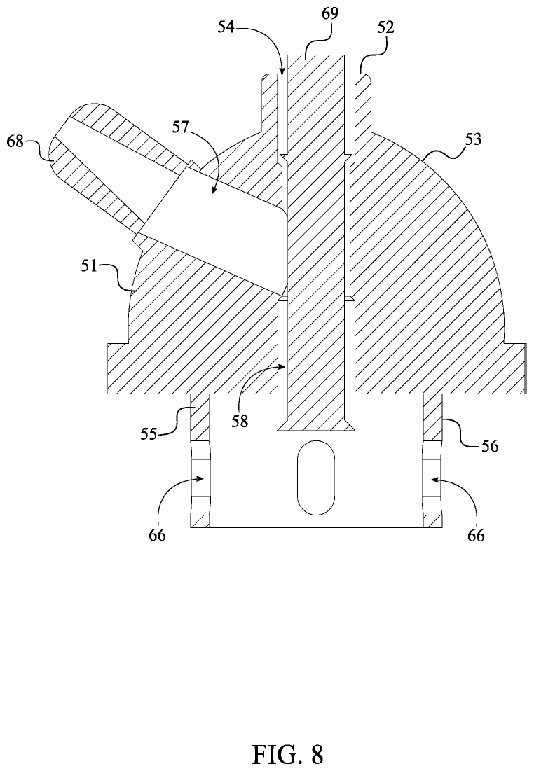

Referring to FIG. 8, the input fitting 68 is concentrically positioned to the inlet opening 57 and hermetically connected onto the lateral surface 53 of the main body 51. In order to discharge grease into the main feed chamber 58, the input fitting 68 is in fluid communication with the inlet opening 57. More specifically, the input fitting 68 is a mechanical device that allows for the flow of grease in one direction. Thus, the input fitting 68 receives the grease through a hand-grease gun, or any other device with similar capabilities.

Referring to FIG. 8, the overflow fitting 69 is a pressure activated pop-up valve for the overall system that ensures that the grease within the present invention is under a specific pressure, therefore regulating the amount of grease within the present invention. If at one point, the internal pressure of the present invention surpasses a specific pressure, the overflow fitting 69 is activated and grease is released through the overflow fitting 69 automatically. In order words, when the internal pressure of the present invention is below the specific pressure, the flow of grease is continuously released into the present invention as the inputted grease is discharged into the plurality of lubricating grooves 13. When the plurality of lubricating grooves 13 is filled with grease, the internal pressure of the present invention exceeds the specific pressure and activates the overflow fitting 69. As a result, the flow of grease is discharged through the overflow opening 54, wherein the overflow opening 54 is delineated by the main feed chamber 58 about the top surface 52.

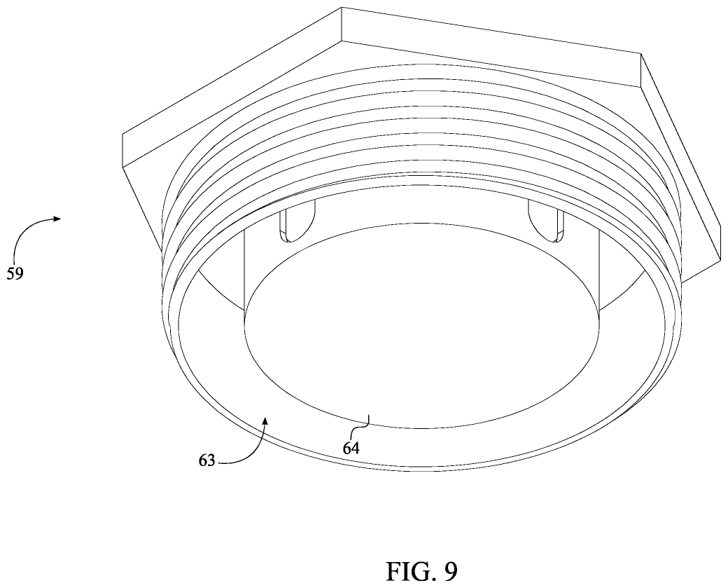

Referring to FIG. 9-11, the coupler 59 that mounts the sealed hydraulic stop valve 9 onto the cap 6 and stays stationary within the present invention comprises a connector wall 60, an outer wall 61, an inner wall 62, a distribution chamber 63, and a base 64. More specifically, the connector wall 60, the outer wall 61, the inner wall 62, and the base 64 are concentrically positioned of each other thus delineating two different compartments. Furthermore, the base 64 and the connector wall 60 are oppositely positioned of each other about the inner wall 62. The inner wall 62 is radially positioned within the outer wall 61. The outer wall 61 is terminally connected to the connector wall 60. The inner wall 62 is terminally connected to the connector wall 60. In other words, the outer wall 61 is perimetrically connected to an outer edge of the connector wall 60. The inner wall 62 is perimetrically connected to an inner edge of the connector wall 60, wherein the connector wall 60 is a ring shaped body. The base 64 is perimetrically connected around the inner wall 62, wherein a receiver compartment is delineated within the base 64 and the inner wall 62. The receiver compartment provides an empty space to receive the tubular attachment 55 so that the grease valve 50 can be rotatably mounted to the coupler 59. More specifically, an outer surface 56 of the tubular attachment 55 is internally positioned to an inner wall 62 of the coupler 59 so that the tubular attachment 55 can be rotatably positioned within the inner wall 62. The distribution chamber 63 is interspaced within the inner wall 62, the outer wall 61, and the connector wall 60 so that the distribution chamber 63 can be opened to the cap 6.

The present invention further comprises a valve-receiving coupler 25 for attaching the coupler 59 to the cap 6 as shown in FIG. 5. The valve-receiving coupler 25 is concentrically integrated into the disk portion 8. More specifically, the valve-receiving coupler 25 comprises a valve hole and a coupling tube. The valve hole traverses through the disk portion 8 and the coupling tube is concentrically positioned with the valve hole, adjacently connected to the disk portion 8. The valve-receiving coupler 25 is internally threaded to interlock with coupler 59. An output fitting 70 that is externally positioned on the outer wall 61 is threadedly attached within the valve-receiving coupler 25.

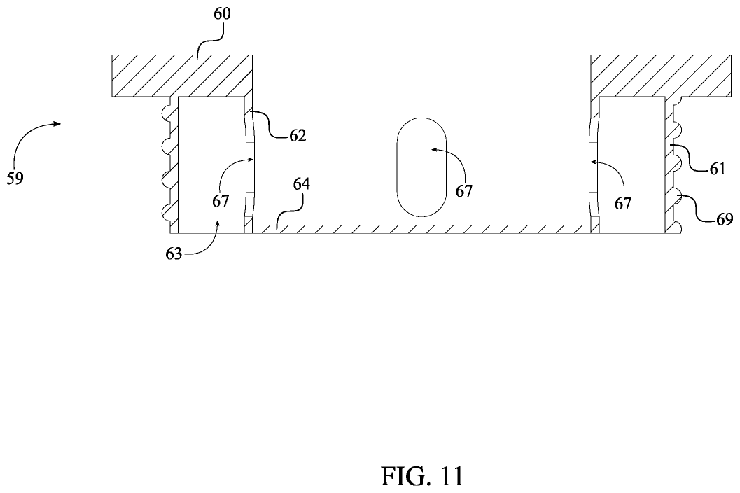

Referring to FIG. 8 and FIG. 11, the plurality of outlet channels 65 comprises at least one valve channel 66 and at least one coupler channel 67 so that the inputted grease can be discharged from the tubular attachment 55 to the distribution chamber 63. More specifically, the valve channel 66 traverses through the tubular attachment 55. The coupler channel 67 traverses through the inner wall 62 of the coupler 59. Furthermore, the valve channel 66 and the coupler channel 67 are radially aligned with each other so that the present invention can be in between an opened configuration and a closed configuration as the grease valve 50 is rotated about the central axis.

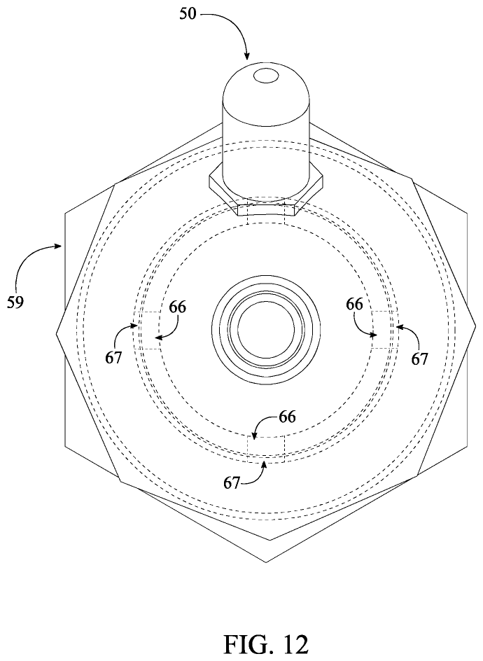

For example, when grease valve 50 is preferably rotated in the counterclockwise direction, the valve channel 66 is concentrically aligned with the coupler channel 67 thus converting the present invention from the closed configuration to the opened configuration as shown in FIG. 12. As a result, the inlet opening 57 is in fluid communication with the distribution chamber 63 through main feed chamber 58, the valve channel 66, and the coupler channel 67 thus allowing the grease to discharge into the plurality of lubricating grooves 13 through the cap 6. However, the present invention can also alternatively convert from the closed configuration to the opened configuration via counterclockwise rotation of the grease valve 50.

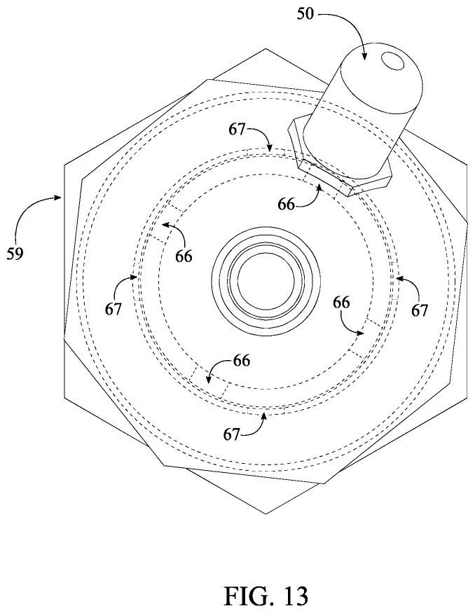

For example, when grease valve 50 is preferably rotated in the clockwise direction, the valve channel 66 is radially offset from the coupler channel 67 thus converting the present invention from the opened configuration to the closed configuration as shown in FIG. 13. As a result, the inlet opening 57 is in fluid communication with the tubular attachment 55 through main feed chamber 58 thus preventing the grease to discharge into the plurality of lubricating grooves 13 through the cap 6. Furthermore, the offset positioning of the valve channel 66 and the coupler channel 67 form a hermetic connection between the cap 6 and the sealed hydraulic stop valve 9. However, the present invention can also alternatively convert from the opened configuration to the closed configuration via clockwise rotation of the grease valve 50.

Although the invention has been explained in relation to its preferred embodiment, it is to be understood that many other possible modifications and variations can be made without departing from the spirit and scope of the invention as hereinafter claimed.

What is claimed is:

1. A sealed hydraulic stop valve for caliper guide pin assembly comprising:
a tubular guide pin;
a cap;
a sealed hydraulic stop valve;
a plurality of lubricating grooves;
the plurality of lubricating grooves being radially distributed about the tubular guide pin;
each of the plurality of lubricating grooves normally traversing into the tubular guide pin from an external surface of the tubular guide pin;
each of the plurality of lubricating grooves traversing into the tubular guide pin from a front surface of the tubular guide pin;
the cap being concentrically positioned with the tubular guide pin;
the cap being positioned about the tubular guide pin, adjacent to the front surface of the tubular guide pin;
the sealed hydraulic stop valve being positioned adjacent to the cap, opposite to the tubular guide pin;
the sealed hydraulic stop valve being adjacently integrated into the cap; and
the sealed hydraulic stop valve being in fluid communication with each of the plurality of lubricating grooves.

2. The sealed hydraulic stop valve for caliper guide pin assembly as claimed in claim 1 comprising:
each of the plurality of lubricating grooves comprising a curved portion and a guide portion;
the curved portion being positioned extending along the tubular guide pin;
the guide portion being positioned adjacent to the front surface of the tubular guide pin;
the guide portion extending from an internal surface of the tubular guide pin to the external surface of the tubular guide pin; and
the guide portion being positioned adjacent to the curved portion.

3. The sealed hydraulic stop valve for caliper guide pin assembly as claimed in claim 1 comprising:
the cap comprising a tubular portion and a disk portion;
the disk portion being concentrically positioned with the tubular portion;
the disk portion being terminally and perimetrically connected to the tubular portion;
the tubular portion being concentrically positioned about the tubular guide pin; and
the disk portion being positioned parallel and adjacent to the front of the tubular guide pin.

4. The sealed hydraulic stop valve for caliper guide pin assembly as claimed in claim 1 comprising:
a lubrication directional plug;
the lubrication directional plug comprising a cylindrical body and a plurality of directional grooves;
the plurality of directional grooves being radially distributed about the cylindrical body;
each of the plurality of directional grooves normally traversing into a front surface of the cylindrical body;
the cylindrical body being concentrically positioned within the tubular guide pin;
the front surface of the cylindrical body being positioned coplanar with the front surface of the tubular guide pin; and
each of the plurality of directional grooves being in fluid communication with a corresponding groove from the plurality of lubricating grooves.

5. The sealed hydraulic stop valve for caliper guide pin assembly as claimed in claim 1 comprising:
a first end of each of the plurality of directional grooves being coincident with each other; and
a second end of each of the plurality of directional grooves being positioned adjacent with the corresponding groove from the plurality of lubricating grooves.

6. The sealed hydraulic stop valve for caliper guide pin assembly as claimed in claim 1 comprising:
an annular groove;
the annular groove being positioned adjacent to a rear surface of the tubular guide pin;
the annular groove laterally traversing into the tubular guide pin from the external surface of the tubular guide pin; and
a distal end of each of the plurality of lubricating grooves being positioned offset from the annular groove.

7. The sealed hydraulic stop valve for caliper guide pin assembly as claimed in claim 1 comprising:
a mounting tube;
the mounting tube being positioned adjacent to a rear surface of the tubular guide pin;
the mounting tube being concentrically positioned within the tubular guide pin; and
the mounting tube being laterally and perimetrically connected to the tubular guide pin.

8. The sealed hydraulic stop valve for caliper guide pin assembly as claimed in claim 1 comprising:
a valve-receiving coupler;
the sealed hydraulic stop valve comprising an output fitting;
the valve-receiving coupler concentrically integrated into a disk portion of the cap;
the output fitting being threadedly attached within the valve-receiving coupler;

9. The sealed hydraulic stop valve for caliper guide pin assembly as claimed in claim 1 comprising:
a lubrication directional plug;
the lubrication directional plug comprising a cylindrical body and a removal hole;
the removal hole concentrically traversing into a front surface of the cylindrical body;
the cylindrical body being concentrically positioned within the tubular guide pin; and
the front surface of the cylindrical body being positioned coplanar with the front surface of the tubular guide pin.

10. The sealed hydraulic stop valve for caliper guide pin assembly as claimed in claim 1 comprising:
the sealed hydraulic stop valve comprising a grease valve, a coupler, a plurality of outlet channels, and an overflow fitting;
the grease valve comprising a main body, a tubular attachment, an inlet opening, and a main feed chamber;
the main body and the tubular attachment being adjacently connected to each other;
the tubular attachment being rotatably mounted within the coupler;
the main feed chamber traversing into the tubular attachment from a top surface of the main body;
the inlet opening traversing into the main feed chamber from a lateral surface of the main body;
the overflow fitting being slidably positioned within the main feed chamber;
the inlet opening being selectively in fluid communication with the coupler through the plurality of outlet channels; and
the inlet opening being selectively in fluid communication with an overflow opening of the main body through the overflow fitting.

11. The sealed hydraulic stop valve for caliper guide pin assembly as claimed in claim 10 comprising:
an input fitting;
the input fitting being concentrically positioned to the inlet opening;
the input fitting being hermetically connected onto the lateral surface of the main body; and
the input fitting being in fluid communication with the inlet opening.

12. The sealed hydraulic stop valve for caliper guide pin assembly as claimed in claim 10 comprising:
the coupler comprising a connector wall, an outer wall, an inner wall, a distribution chamber, and a base;
the connector wall, the outer wall, the inner wall, and the base being concentrically positioned of each other;
the base and the connector wall being oppositely positioned of each other about the inner wall;
the inner wall being radially positioned within the outer wall;
the outer wall being terminally connected to the connector wall;
the inner wall being terminally connected to the connector wall;
the base being perimetrically connected around the inner wall; and
the distribution chamber being interspaced within the inner wall, the outer wall, and the connector wall.

13. The sealed hydraulic stop valve for caliper guide pin assembly as claimed in claim 10 comprising:
an outer surface of the tubular attachment being internally positioned to an inner wall of the coupler; and
the tubular attachment being rotatably positioned within the inner wall.

14. The sealed hydraulic stop valve for caliper guide pin assembly as claimed in claim 10 comprising:
the plurality of outlet channels comprising at least one valve channel and at least one coupler channel;
the valve channel traversing through the tubular attachment;
the coupler channel traversing through an inner wall of the coupler; and
the valve channel and the coupler channel being radially aligned with each other.

15. The sealed hydraulic stop valve for caliper guide pin assembly as claimed in claim 14 comprising:
an opened configuration;
the valve channel being concentrically aligned with the coupler channel; and
the inlet opening being in fluid communication with a distribution chamber of the coupler through main feed chamber, the valve channel, and the coupler channel.

16. The sealed hydraulic stop valve for caliper guide pin assembly as claimed in claim 14 comprising:
a closed configuration;
the valve channel being radially offset from the coupler channel; and
the inlet opening being in fluid communication with the tubular attachment through the main feed chamber.

17. The sealed hydraulic stop valve for caliper guide pin assembly as claimed in claim 10, wherein the overflow fitting is a pressure activated pop-up valve.

18. The sealed hydraulic stop valve for caliper guide pin assembly as claimed in claim 10, wherein the overflow opening by the main feed chamber about the top surface.
